(19) United States
(12) Patent Application Publication
(10) Pub. No.: US 2004/0034549 A1
(43) Pub. Date: Feb. 19, 2004

(54) System and method for accessing critical care medical management information

(76) Inventors: Alan D. Winston, Overland Park, KS (US); Eric A. Summerour, Olathe, KS (US); Paul David White, Shawnee, KS (US)

Correspondence Address: LATHROP & GAGE LC, 2345 GRAND AVENUE, SUITE 2800, KANSAS CITY, MO, 64108, US

(21) Appl. No.: 10/222,047

(22) Filed: Aug. 16, 2002

(51) Int. Cl. G06F 17/60

(52) U.S. Cl. 705/3

(57) ABSTRACT

A system for providing automated decision support mapping for making referrals to the correct type of medical case manager for critical care patients experiencing catastrophic medical conditions. In one aspect, the system provides a method for integrating medical care management functions for a health care case by receiving a referral form containing referral information and case information related to medical status of a critical care patient; storing the referral information in a referral record in a database; storing the case information in a patient status record in the database; and entering, into the database, updated case information comprising changes in a patient's medical status

### TECHNICAL FIELD

The present invention relates generally to medical, financial and health plan benefits information systems, and more particularly, to a system and method for quickly and accurately accessing the necessary information related to the management of medical services and financial exposure for catastrophic events and out of network claims.

### STATEMENT OF THE PROBLEM

The health care payor segment of the healthcare industry incurs substantial risk of major expenditures when dealing with catastrophic events such as severe bums/trauma, organ transplants, and the like. The financial exposure to the risk is not always directly related to just the level of medical severity of the patient's medical condition. A large portion of the financial exposure is directly related to the quality and efficiency of the many disparate and complex communication processes, as well as the financial and employee benefits management and control systems that are used to manage catastrophic events. This phenomenon is known as ‘process risk variation’. In order to minimize this risk, it is essential to reduce the variations in the time required to complete the administratively complex process of ‘case’ referral to qualified medical care management vendors and in the dissemination of necessary status information to case management staffs. In order to gain assurance that decisions are being made with current information, hosting a central repository where medical, financial and benefits administrative information can be efficiently retrieved on timely basis is critical.

Current processes for case referral to the appropriate medical care management program and the look-up of information of medical progress, insurance claim status, and financial exposure are cumbersome and predominantly manual. The cycle time of the case referral process is typically between seven to eleven business days from the point of diagnosis to the completion of the referral. This cycle results from having to accesses disparate and complex systems. Furthermore, claim status look-up alone may take up to a few days. What is needed is a system that integrates these disparate processes and allows expeditious tracking of, and access to medical status, benefits administration and financial information throughout the catastrophic event management process.

### SOLUTION TO THE PROBLEM

The present system provides automated decision support mapping for making referrals to the correct type of medical case manager for critical care patients experiencing catastrophic medical conditions, and integrates case referral, patient status updates, and reporting.

In one aspect, a method is provided for storing, accessing, and tracking medical care management information for a health care case by entering, for the case, case information related to medical status of a critical care patient into an electronic referral form; sending the referral form to a reinsurance carrier via the Internet; storing the case information in a patient status record in a database; sending a copy of the referral form, via the Internet, to a managed care vendor and to case management personnel; entering, in the database, updated case information comprising changes in the medical status; sending information including updated case information to the vendor and to the case management personnel; and storing, in each patient status record, benefits administration information including the updated case information, related to the case.

In another aspect, a method is provided for storing, accessing, and tracking medical care management information for a health care patient affiliated with a client for whom a carrier provides reinsurance, by presenting an electronic referral form on a carrier web site; creating a referral by receiving, via the Internet, referral information related to medical status of the patient entered into the electronic referral form; storing the referral information in a client referral record in a database managed by the carrier; sending the referral information to a medical care management vendor via the Internet; wherein, if the vendor accepts the referral, an acceptance message is sent, via the Internet, to the client; and updating patient status information stored in the database, via the Internet, to indicate changes in status of the patient; wherein a query facility for querying the database for the referral information and the patient status information is provided by the server, via the Internet, to the client, the carrier, and the vendor.

In another aspect, a system is provided which includes a carrier site including a server coupled to the Internet, to a carrier web site and to a carrier database; at least one vendor coupled to the Internet; and at least one client site coupled to the Internet; wherein the database contains referral information for the patient and information concerning the medical status of the patient; wherein a client creates a referral by sending referral information concerning medical status of the patient, from the client site to the carrier web site, via the Internet; wherein the referral information is stored in the carrier database; and wherein a medical care management vendor receives, via the Internet, the referral information that was stored in the carrier database.

In another aspect, a method is provided for creating and managing a referral for a health care patient affiliated with a client for whom a carrier provides reinsurance, by accessing a carrier web site to view an electronic referral form; selecting a new referral page on the web site; creating a referral by entering, for the patient, referral information concerning medical status of the patient into the electronic referral form; sending the referral information to a carrier server; storing the referral information in a referral record in a database managed by the carrier; selecting a medical care management vendor using the referral information; updating the referral record to indicate that the referral was made to the selected vendor; sending the referral information to the vendor via the Internet; sending a verification of the referral to the client via the Internet; and sending the referral information to case management personnel.

In another aspect, a method is provided for storing, accessing, and tracking medical care management information a health care patient affiliated with a client for whom a carrier provides reinsurance, by creating a referral by receiving, via the Internet, referral information concerning medical status of the patient into an electronic referral form; storing the referral information in a client referral record in a database managed by the carrier; and determining whether the client is set up as a direct client that does not require acceptance of the referral by the carrier; wherein, if the client is not a direct client, the carrier reviews the referral information to determine whether to accept the referral, and sends the referral information to a medical care management vendor via the Internet if the carrier accepts the referral; and wherein, if the client is a direct client, the referral information is sent to the vendor via the Internet, and the carrier reviews the referral information to determine whether to accept the referral; and if the vendor accepts the referral, an acceptance message is sent, via the Internet, to the client.

In another aspect, a method is provided for integrating medical care management functions for a health care case by receiving, via the Internet, a referral form containing referral information and case information related to medical status of a critical care patient; storing the referral information in a referral record in a database; storing the case information in a patient status record in the database; entering, into the database, updated case information comprising changes in the medical status; and generating, in response to a query, a report including the case information.

The present system reduces the cycle for case referrals to as little as several hours in some instances, and generally no more than 1-2 days. Claim status look-up is typically reduced to a few minutes. Clients benefit by having earlier intervention, and therefore lower medical costs on severe catastrophic cases and outof-network claims, as well as lower administration costs from reduced cycle time in some major processes, e.g., precertification, utilization review, case management and claims adjudication.

Benefits of the present system may include some or all of the following:

improved care management;

lower claims costs;

lower administrative costs;

improved case management communication;

reduced case referral cycle time;

the ability to view referral information, and view summary reports of referral activity; and

a central repository of integrated clinical, financial and benefits administration information.

### BRIEF DESCRIPTION OF THE DRAWINGS

FIG. 1 is a diagram illustrating exemplary components of one embodiment of the present system;

FIG. 2 is a high-level flowchart illustrating exemplary steps which may be performed in practicing one embodiment of the present method;

FIG. 3 is a flowchart illustrating, in greater detail, exemplary steps which may be performed in the referral process of the present method; and

FIG. 4 is a diagram illustrating exemplary types of records stored in the carrier database.

### DETAILED DESCRIPTION

The present system provides automated decision support mapping for making referrals to the correct type of medical case manager for critical care patients experiencing catastrophic medical conditions. The parties involved in the case referral process include the medical/clinical care management provider (a ‘managed care vendor’), a reinsurer (the ‘carrier’), and a client or customer of the reinsurer. The reinsurer provides reinsurance coverage to the customer's health insurance coverage. For example, where a reinsurer's customer submits claims that total more than the customer's deductible in a policy period, the reinsurer will reimburse the customer for the amount that the member's claims exceed the deductible. Initially, case referrals are electronically submitted to the specialized clinical care provider (the vendor). After information concerning a patient's medical circumstances is entered into an online referral form by a client, the present system, in an exemplary embodiment, either (a) electronically forwards the referral for processing by case management personnel (e.g., case nurses) at the carrier, which then forwards the referral on to the vendor, if appropriate; or (b) forwards the referral directly to case management personnel at the carrier and the vendor at the same time. The particular scenario that is used is determined at the time of system implementation.

In either scenario (a) or (b), the present system stores the referral information in a database, and generates reports which can be downloaded by the client, the carrier, and vendors. The client may then log on to the system via the carrier web site for details (in the situation wherein that the vendor has agreed to accept the additional administrative functions). In one aspect, the system provides the capability to attach and store in each individual case record the most current information from various disparate systems, e.g., case management reports, financial and cost information as well as benefits administration information. Any one of the three parties (vendor, carrier or client) can subsequently access this information.

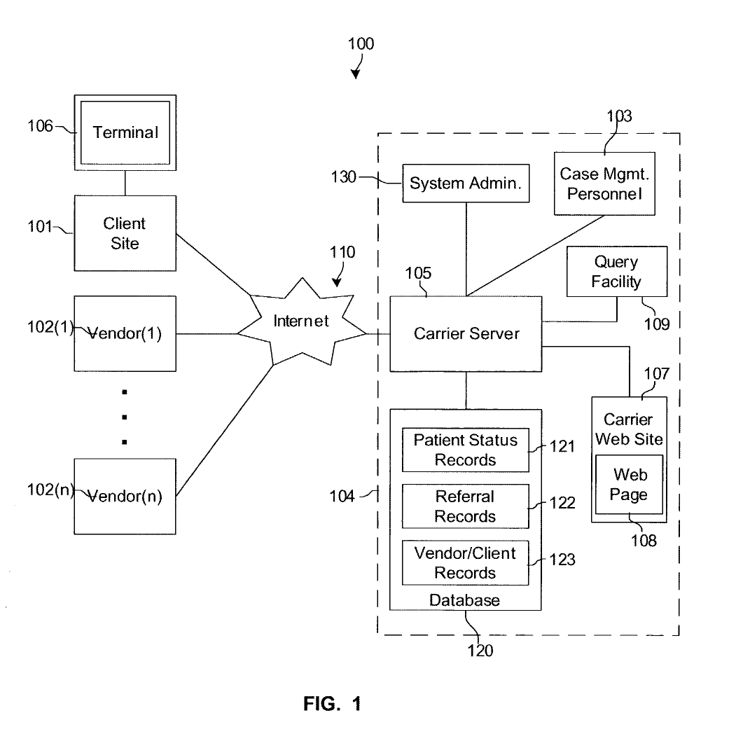

FIG. 1 is a diagram illustrating exemplary components of one embodiment of the present system 100. As shown in FIG. 1, a client site 101 and a plurality of vendors 102(1)-102(n) are connected, via the Internet 110, to a server 105 at carrier site 104. Only a single client site is shown in FIG. 1, although a plurality of client sites may be included in the present system 100. Each of the vendors 102(*) is a specialized managed care provider which provides one or more types of non-routine clinical management, disease management, or medical claims support. Carrier site 104 also includes a web site 107 and a database 120 managed by the carrier. The carrier site may also include a system administrator function 130 and on-site case management personnel 103, such as case nurses. Database 120 may include patient status records 121, client referral records 122, and vendor/client records 123.

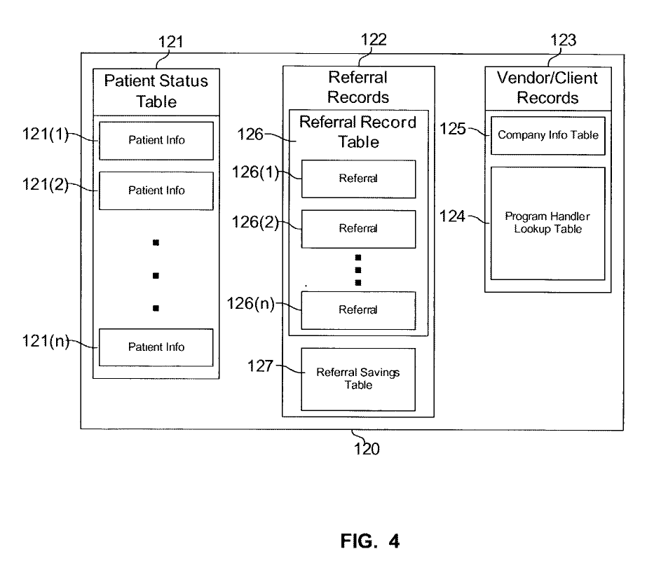

FIG. 4 is a diagram illustrating exemplary types of records stored in the carrier database 120. These records may include the types of records listed below:

Patient Status Table 121—stores patient status records 121(*) containing patient benefits administration information.

Referral Record Table 126—main table which contains each referral record 126(1)-126(n).

Referral Savings Table 127—stores financial information for each accepted referral.

Program Handler Lookup Table 124—specifies the program and vendor that goes with each ‘type of event’ or ‘type of referral’. This data is used when the vendor is selected based on the referral type selected on a referral form.

Company Information Table 125—stores all of the demographic info on each client/vendor (address, city, state, phone, etc.).

Contents of database 120, as shown in FIG. 4, are described below throughout this document.

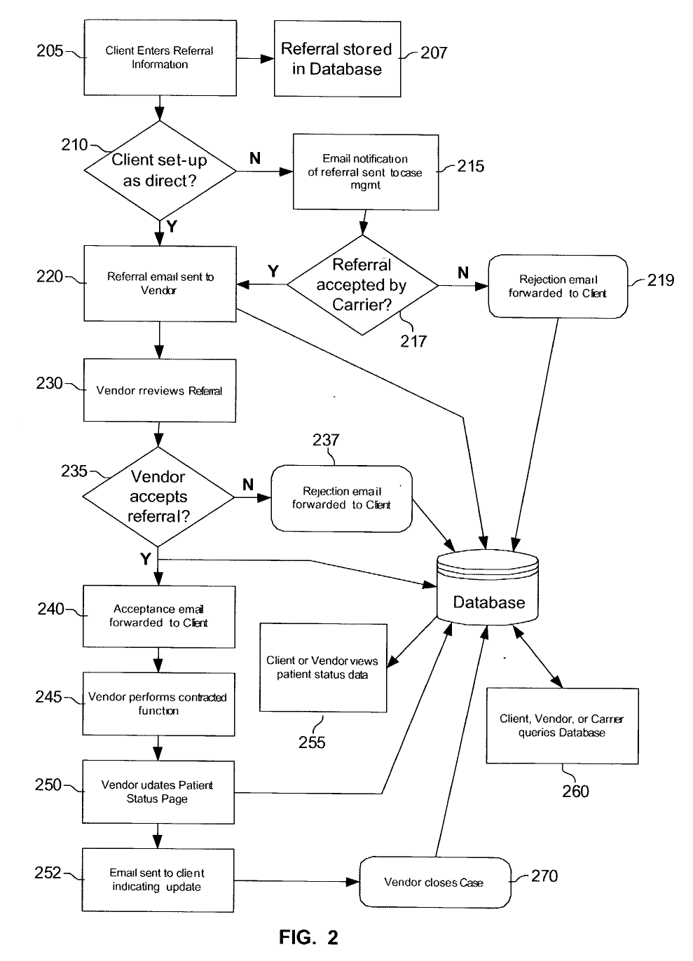

FIG. 2 is a high-level flowchart illustrating exemplary steps which may be performed in practicing one embodiment of the present method. As shown in FIG. 2, at step 205, a client, at client site 101, accesses a web page 108 on carrier web site 107 to view an electronic referral form. To create a referral, the client then enters referral information, for a patient affiliated with the client, into a referral form via a computer terminal 106, logged on to carrier web site 107. The referral information entered by the client is sent, via the Internet, to server 105, which stores the referral information as a referral record 126(*) in database 120 (step 207). In an exemplary embodiment, all communications between client, carrier, and vendor, as described herein, are transmitted via the Internet. However, communications described herein as being transmitted via the Internet may, alternatively, be transmitted via a private network, or a combination of the Internet and a private network.

At step 210, server 105 determines, using information in Company Information Table 125, if the client is set up as a ‘direct’ client, i.e., a client that has a pre-arranged agreement with the carrier to send referrals directly to a particular vendor. If so, referral processing continues at step 220, described below. If the client is not a ‘direct’ client, then an email message indicating that the referral has been made to this vendor is sent to the carrier, at step 215.

At step 217, after receiving the email notification of a new referral, a person in carrier management 103 logs on to carrier web site 107 to review the referral to determine whether to accept the referral. If the referral is not accepted, the carrier case management person indicates this on the carrier web site 107. An email message, indicating that that the referral has been rejected, is then sent to the client, at step 219, and database 120 is updated to indicate the rejection. If, at step 217, the referral is accepted by the carrier, the carrier case management personnel indicates this on carrier web site 107 (or, alternatively, if the client was set up as a ‘direct’ client at step 210), then at step 220, an email message containing the referral information is sent, via the Internet, to the vendor notifying them of a new referral.

In the situation where the referral is sent to the carrier, the carrier (reinsurer) is responsible for processing referrals and forwarding only appropriate referrals on to the correct vendor. This setup is specifically designed for clients who require a review by the carrier's case management staff. In the situation where a ‘direct’ client setup is in effect, the carrier is copied for the purpose of staying informed, and is not required to take any action.

At step 230, after receiving the email notification of a new referral, the selected vendor 102(*)enters carrier web site 107 and reviews the referral information, and at step 235, the vendor determines whether to accept the referral. If the vendor decides not to accept the referral, the vendor indicates this on carrier web site 107, then at step 237, an email message, indicating that that the referral has been rejected, is sent to the client. Database 120 is updated accordingly to indicate the rejection. If the vendor decides to accept the referral, the vendor indicates this on carrier web site 107, then at step 240, an email message, indicating that that the referral has been accepted, is sent to the client, and database 120 is updated to indicate the acceptance, at step 240.

At step 245, the vendor which has accepted the referral proceeds to carry out the function for which it has been contracted to perform. This function may include tasks such as clinical management, repricing of claims, providing specialty drugs, and the like.

At step 250, vendor 102(*) updates information on a Patient Status web page 108 on the carrier web site 107, as necessary, causing a record 121(*) in the Patient Status Table 121 in database 120 to be updated, or causes the record 121(*) to be initially populated, if this is the first such action by the vendor. At step 252, when the patient status page is updated, server 105 automatically sends an email message to the appropriate client site 101 indicating that a patient's status has changed. Both the client and the carrier may check status of a patient (at step 255) by viewing a Patient Status page on carrier web site 107. Server 105 provides a query facility 109 for querying Database 120 (at step 260) via an appropriate Reports web page on web site 107 by either the client, the vendor, or the carrier, at any time. If the database 120 contains the requested information, query facility 109 generates an appropriate report in response to the query. Pre-coded queries, available on web site 107, may be used by clients to generate reports including patient status reports and utilization reports indicating the number of referrals, and savings reports (indicating financial information such as value of services). Information for generating the reports is located in database records including Patient Status Table 121, Referral Record Table 126, and Referral Savings Table 127.

Finally, at step 270, the vendor closes the case by entering appropriate information on Patient Status web page on carrier web site 107.

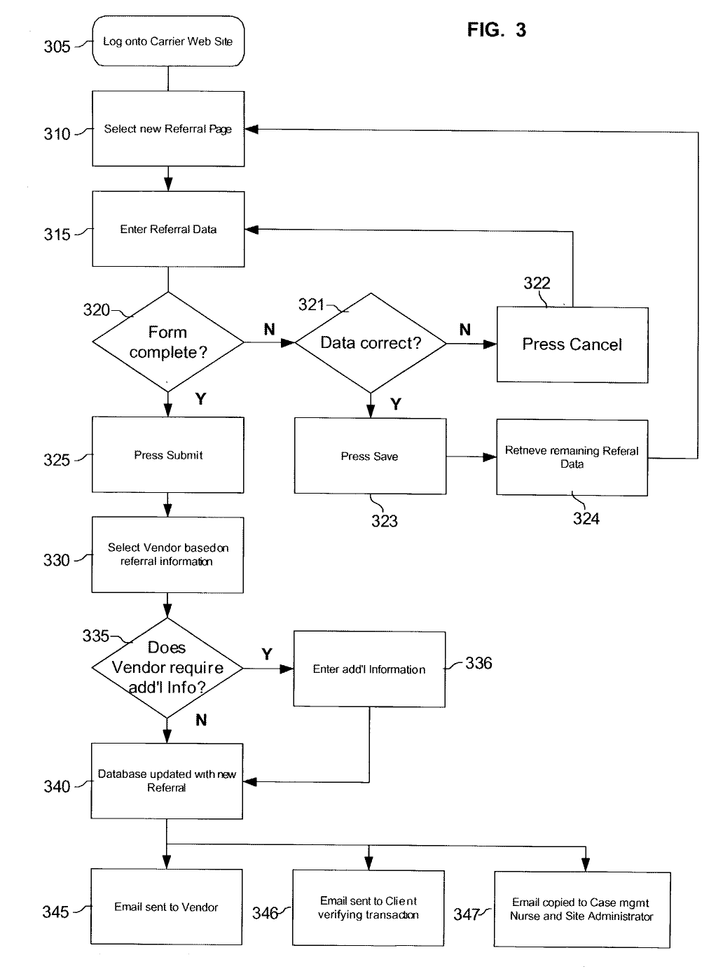

FIG. 3 is a flowchart illustrating, in greater detail, exemplary steps which may be performed in the referral process of the present method. As shown in FIG. 3, at step 305, a client at client site 101 logs on to carrier web site 107. The carrier web site 107 includes a menu that allows a viewer of the site to select from a number of options. In the present case, the client selects a new referral form from the menu, at step 310, which causes a referral web page 108 to be displayed. At step 315, the client enters referral information which includes, for example, the following data:

Name and contact information for person making referral;

Company information from person making referral;

Patient data;

Benefits administration information;

Type and category of referral;

Clinical data;

Relevant dates; and

Health care facility information.

At step 320, if the referral form has been completed, the client clicks on a ‘Submit’ button on the web page 108 at step 325, which causes the referral information to be transmitted to carrier server 105, which stores the information in a referral record 126(*) in database 120. Otherwise, if the client, for example, does not presently have all necessary information, two options are available. At step 321, if the data entered is correct, but not complete, the client may click on a ‘Save’ button, at step 323, which saves, in database 120, the data that was entered so that it can be retrieved at a later time, at step 324. If the data is incorrect, or if the client wishes to enter all of the data at a later time, a ‘Cancel’ button may be clicked on, at step 322. The client then has the option of re-entering the referral data at step 315.

Once a client has submitted a referral to the server at carrier site 104, then at step 330, server 105 automatically determines the appropriate vendor 102(*) by using a decision support algorithm driven by the diagnosis or treatment data contained in the referral information submitted for a particular case, and which, in one embodiment, uses a ‘program handler’ lookup table 124 in database 120 to identify the appropriate vendor. For example, if the client has a patient in need of a heart transplant, the referral is then automatically forwarded to a pre-designated transplant management vendor that is appropriate for that patient.

At step 335, if the vendor requires additional information from the client, the additional information is entered at step 336 in response to a message on the web page 108. At step 340, the carrier server 105 updates a referral record 126(*) in database 120, to indicate that the referral was made to the selected vendor 102(*). Finally, an email message is sent to all appropriate personnel at the vendor 102(*) (step 345), to provide notification of the referral; an email message verifying the transaction is sent to the client (step 346); and the appropriate case management personnel 103 (e.g., a case management nurse) and site system administrator 130 are copied on the correspondence, at step 347.

While exemplary embodiments of the present invention have been shown in the drawings and described above, it will be apparent to one skilled in the art that various embodiments of the present invention are possible. For example, the specific configuration of the database 120 as well as the specific steps described with respect to the flowcharts in FIGS. 2 and 3, should not be construed as limited to the specific embodiments described herein. Modification may be made to these and other specific elements of the invention without departing from its spirit and scope as expressed in the following claims.

What is claimed is:

1. A method for storing, accessing, and tracking medical care management information for a health care case comprising the steps of:
entering, for said case, case information for a critical care patient into an electronic referral form;
sending the referral form to a reinsurance carrier via a network;
storing the case information in a patient status record in a database;
sending a copy of the referral form, via a network, to a medical care management vendor and to case management personnel;
entering, in the database, updated case information comprising changes in said medical status; and
sending information including updated case information to the client and to the case management personnel.

2. The method of claim 1, including the additional step of generating a report including information in said patient status record.

3. The method of claim 1, including the additional step of generating, in response to a query, a report comprising financial information related to the case

4. A method for storing, accessing, and tracking medical care management information for a health care patient affiliated with a client for whom a carrier provides reinsurance, the method comprising the steps of:
presenting an electronic referral form on a carrier web site;
creating a referral by receiving, via the Internet, referral information for the patient entered into the electronic referral form;
storing the referral information in a client referral record in a database managed by the carrier;
sending the referral information to a managed care vendor via the Internet;
wherein, if the vendor accepts the referral, an acceptance message is sent, via the Internet, to the client; and
updating patient status information stored in the database, via the Internet, to indicate changes in status of the patient;
wherein a query facility for querying the database for said referral information and said patient status information is provided by the server, via the Internet, to the client, the carrier, and the vendor.

5. The method of claim 4, including the step of updating said patient status information stored in the database.

6. The method of claim 5, wherein the patient status information that is updated includes patient benefits administration information.

7. The method of claim 4, including the step of updating financial information relating to said referral, stored in the database.

8. The method of claim 4, wherein the vendor accesses a report generated via a query submitted to the carrier web site, to retrieve information, stored in the carrier database, related to said referral.

9. The method of claim 4, wherein the vendor accesses a report generated via a query submitted to the carrier web site, to retrieve information, stored in the carrier database, related to the status of the patient.

10. A system for accessing, tracking and storing medical care management information for a health care patient affiliated with a client for whom a carrier provides reinsurance, the system comprising:
a carrier site including a server coupled to a network, to a carrier web site and to a carrier database;
at least one managed care vendor coupled to the network; and
at least one client site coupled to the network;
wherein said database contains referral information for the patient and information concerning the medical status of the patient;
wherein a client creates a referral by sending referral information for the patient, from the client site to the carrier web site, via the network;
wherein the referral information is stored in the carrier database; and
wherein the managed care vendor receives, via the Internet, said referral information that was stored in the carrier database.

11. The system of claim 10, wherein the vendor updates said information, stored in the carrier database, concerning the medical status of the patient.

12. The system of claim 10, including a query facility for querying the carrier database for said referral information and said patient status information, via the network, by the client, the carrier, and the vendor.

13. The system of claim 10, wherein said vendor is automatically selected using a decision support algorithm driven by data contained in the referral information.

14. A method for creating and managing a referral for a health care patient affiliated with a client for whom a carrier provides reinsurance, the method comprising the steps of:
accessing a carrier web site to view an electronic referral form;
selecting a new referral page on the web site;
creating a referral by entering referral information for said patient into the electronic referral form;
sending the referral information to a carrier server;
storing the referral information in a referral record in a database managed by the carrier;
selecting a managed care vendor using the referral information;
updating said referral record to indicate that the referral was made to the selected vendor;
sending the referral information to the vendor via a network;
sending a verification of the referral to the client via a network; and
sending the referral information to case management personnel.

15. The method of claim 14, wherein said vendor is automatically selected using a decision support algorithm driven by data contained in the referral record.

16. The method of claim 14, including the step of saving the referral information entered in the creating step to allow the retrieval thereof at a later time.

17. The method of claim 14, including the step of retrieving the referral information that was saved in that step.

18. A method for storing, accessing, and tracking medical care management information a health care patient affiliated with a client for whom a carrier provides reinsurance, the method comprising the steps of:
creating a referral by receiving, via the Internet, referral information for the patient into an electronic referral form;
storing the referral information in a client referral record in a database managed by the carrier; and
determining whether the client is set up as a direct client that does not require acceptance of the referral by the carrier;
wherein, if the client is not a direct client, the carrier reviews the referral information to determine whether to accept the referral, and sends the referral information to a managed care vendor via the Internet if the carrier accepts the referral; and
wherein, if the client is a direct client, the referral information is sent to the vendor via the Internet, and the carrier reviews the referral information to determine whether to accept the referral; and if the vendor accepts the referral, an acceptance message is sent, via the Internet, to the client.

19. The method of claim 18, including the step of updating patient status information stored in the database, via the Internet, to indicate changes in status of the patient.

20. The method of claim 18, wherein a query facility for querying the database for said referral information and said patient status information is provided by the server, via the Internet, to the client, the carrier, and the vendor.

21. A method for integrating medical care management functions for a health care case comprising:
receiving, via a network, from a client of a reinsurance carrier, referral information and case information for a critical care patient;
storing the referral information in a referral record in a database managed by the carrier;
storing the case information in a patient status record in the database;
entering into the database, via the network, updated case information comprising a change in said medical status; and
sending the referral information via the network to a managed care vendor.

22. The method of claim 21, including the step of generating, in response to a query, a report including said case information has been entered into the database.

23. The method of claim 21, including the step of generating, in response to a query, a report comprising financial information related to the case.

24. The method of claim 21, including the step of automatically selecting the managed care vendor using the referral information.

25. The method of claim 21, including the step of automatically sending a message to a client, via the network, indicating said change in said medical status when said updated case information is entered into the database.

26. The method of claim 21, including the step of determining whether the client is set up as a direct client that does not require acceptance of the referral by the carrier;
wherein, if the client is not a direct client, the carrier reviews the referral information to determine whether to accept the referral, and sends the referral information to a managed care vendor via the network if the carrier accepts the referral; and
wherein, if the client is a direct client, the referral information is sent to the vendor via the network, and the carrier reviews the referral information to determine whether to accept the referral; and if the vendor accepts the referral, an acceptance message is sent, via the network, to the client.

27. A system for integrating medical care management functions for a health care case comprising:
means for receiving, via a network, a referral form containing referral information and case information for a critical care patient;
means for storing the referral information in a referral record in a database;
means for storing the case information in a patient status record in the database;
means for entering, into the database via the network, updated case information comprising changes in said medical status; and
means for automatically selecting a managed care vendor using the referral information.

28. The system of claim 27, including means for generating, in response to a query, a report comprising financial information related to the case.

29 The system of claim 27, including means for generating, in response to a query, a report including said case information.

30. The system of claim 27, including means for determining whether the client is set up as a direct client that does not require acceptance of the referral by the carrier;
wherein, if the client is not a direct client, the carrier reviews the referral information to determine whether to accept the referral, and sends the referral information to a managed care vendor, via the Internet, if the carrier accepts the referral; and
wherein, if the client is a direct client, the referral information is sent to the vendor via the Internet, and the carrier reviews the referral information to determine whether to accept the referral; and if the vendor accepts the referral, an acceptance message is sent, via the Internet, to the client.
